(19) United States
(12) Patent Application Publication
(10) Pub. No.: US 2012/0245912 A1
(43) Pub. Date: Sep. 27, 2012

(54) METHOD OF AND APPARATUS FOR DETERMINING OPTIMAL PARAMETERS FOR MEASURING BIOLOGICAL SIGNALS BASED ON VIRTUAL BODY MODEL

(76) Inventors: Byung-hoon Ko, Hwaseong-si (KR); Sang-kon Bae, Seongnam-si (KR); Eun-bo Shim, Chuncheon-si (KR); Kun-soo Shin, Seongnam-si (KR); Min-soo Gyeon, Chuncheon-si (KR); Jae-won Jeon, Seoul (KR); Seong-bae Hong, Ansan-si (KR); Ki-moo Lim, Chuncheon-si (KR); Ah-jin Ryu, Dongducheon-si (KR); Jeong-jae Lee, Chuncheon-si (KR); Jin-ho Song, Wonju-si (KR)

(21) Appl. No.: 13/406,958

(22) Filed: Feb. 28, 2012

(30) Foreign Application Priority Data
Mar. 23, 2011 (KR) 10-2011-0025888

(51) Int. Cl. G06F 19/12; G06G 7/60

(52) U.S. Cl. 703/11

(57) ABSTRACT

A method of determining optimal parameters for measuring biological signals of a real body by using a virtual body model modeling a virtual body simulating the real body includes generating a plurality of virtual biological signals of the virtual body using the virtual body model by changing parameters that determine characteristics of the virtual biological signals; selecting at least one of the virtual biological signals based on a characteristic of one of the biological signals of the real body; and outputting at least one parameter used to generate the selected at least one virtual biological signal as at least one optimal parameter for measuring the one biological signal of the real body.

### CROSS-REFERENCE TO RELATED APPLICATIONS

This application claims the benefit of Korean Patent Application No. 10-2011-0025888 filed on Mar. 23, 2011, in the Korean Intellectual Property Office, the disclosure of which is incorporated herein by reference in its entirety.

### BACKGROUND

1. Field

This disclosure relates to methods and apparatuses for determining parameters, and more particularly, to methods and apparatuses for determining optimal parameters for measuring biological signals.

2. Description of the Related Art

As more people become interested in U-Health (the Ubiquitous Health initiative underway in South Korea) and similar initiatives underway elsewhere in the world, technologies for monitoring and analyzing vital signs of a patient in daily life are in demand. Examples of applied technologies for monitoring and analyzing vital signs in daily life are electrocardiogram (ECG) measurement using fiber-type electrodes, heartbeat measurement using a wristband-type, glove-type, or ring-type module, etc. Such applied technologies focus on mobile use by being miniaturized and being combined with wired/wireless communication technologies. The determination of parameters used for measuring biological signals of an examinee is an important factor for manufacturing and using a mobile device for measuring biological signals.

### SUMMARY

According to an aspect of the invention, a method of determining optimal parameters for measuring biological signals of a real body by using a virtual body model modeling a virtual body simulating the real body includes generating a plurality of virtual biological signals of the virtual body using the virtual body model by changing parameters that determine characteristics of the virtual biological signals; selecting at least one of the virtual biological signals based on a characteristic of one of the biological signals of the real body; and outputting at least one parameter used to generate the selected at least one virtual biological signal as at least one optimal parameter for measuring the one biological signal of the real body.

According to another aspect of the invention, a computer-readable recording medium has recorded therein a computer program for controlling a computer to perform the method of determining optimal parameters.

According to another aspect of the invention, a parameter determining apparatus for determining optimal parameters for measuring biological signals of a real body by using a virtual body model modeling a virtual body simulating the real body includes a database configured to store the virtual body model; a processor configured to generate a plurality of virtual biological signals of the virtual body using the virtual body model by changing parameters that determine characteristics of the virtual biological signals; select at least one of the virtual biological signals based on a characteristic of one of the biological signals of the real body; and store the selected at least one virtual biological signal and at least one parameter used to generate the selected at least one virtual biological signal in the database; and an output unit configured to output the at least one parameter used to generate the selected at least one virtual biological signal as at least one optimal parameter for measuring the one biological signal of the real body.

Additional aspects of the invention will be set forth in part in the description that follows and, in part, will be apparent from the description, or may be learned by practice of the embodiments described below.

### BRIEF DESCRIPTION OF THE DRAWINGS

The above and/or other aspects will become apparent and more readily appreciated from the following description of embodiments, taken in conjunction with the accompanying drawings in which:

FIG. 1 is a diagram of a parameter determining device according to an embodiment of the invention;

FIG. 2 is a diagram showing the configuration of a processor according to an embodiment of the invention;

FIG. 3 is a diagram showing a process of configuring a virtual body model;

FIG. 4 shows locations of virtual electrodes and an example in which at least one of the locations is changed;

FIG. 5 shows a plurality of virtual biological signals;

FIG. 6 is a diagram showing waveform characteristics of a plurality of virtual biological signals and information regarding locations mapped to the waveform characteristics;

FIG. 7 is a flowchart of a method of determining parameters according to an embodiment of the invention;

FIG. 8 is a flowchart of a method of determining parameters according to an embodiment of the invention; and

FIG. 9 is a flowchart of a method of determining parameters according to an embodiment of the invention.

### DETAILED DESCRIPTION

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are merely described with reference to the figures to explain aspects of the description.

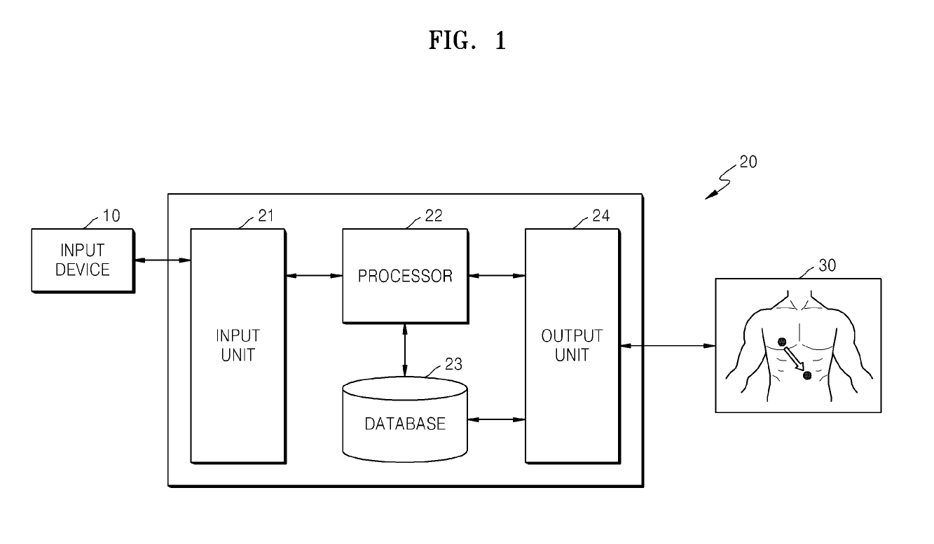

FIG. 1 is a diagram of a parameter determining device 20 according to an embodiment of the invention. The parameter determining device 20 shown in FIG. 1 determines optimal parameters used for measuring biological signals of a real body. Here, examples of the parameters are information regarding locations of measuring electrodes for measuring biological signals of a real body. The information regarding locations of measuring electrodes may include one or more of locations at which one or more of the measuring electrodes are attached to the skin of the real body, distances between the measuring electrodes, and directions from the measuring electrodes to other ones of the measuring electrodes. However, the invention is not limited thereto.

The parameter determining device 20 determines optimal parameters by using a virtual body model. Generally, a virtual body model refers to a virtual model representing a real body. In other words, instead of repeatedly measuring biological signals by using a real biological signal measuring device, the parameter determining device 20 may determine optimal parameters by using a virtual body model. Here, the optimal parameters are used for measuring actual biological signals. As described above, the optimal parameters include information regarding locations of measuring electrodes for measuring biological signals of a real body.

The parameter determining device 20 generates a plurality of virtual biological signals by using a virtual body model, selects virtual biological signals indicating characteristics of a real body from among the plurality of virtual biological signals, and outputs parameters of the selected virtual biological signals as the optimal parameters. Generally, the parameter determining device 20 may compare characteristics of the plurality of virtual biological signals to each other and select any one of the plurality of virtual biological signals having a characteristic that best matches a characteristic of a real body as a virtual biological signal indicating a characteristic of the real body. Here, a characteristic of a real body may refer to a waveform characteristic, but the invention is not limited thereto.

Characteristics of biological signals of a real body are input from an input device 10. The input device 10 is an interface via which a user, such as a medical expert, inputs commands or information. The input device 10 may be a general input device, such as a keyboard, a mouse, etc. Alternatively, the input device 10 may be a graphical user interface (GUI) displayed on a display device 30. The parameter determining device 20 selects any one of the plurality of virtual biological signals by using characteristics of biological signals of a real body that are input via the input device 10. Alternatively, the characteristics of biological signals of a real body may be predetermined as default values.

The display device 30 displays parameters input by the parameter determining device 20. Here, the parameters may be information regarding locations of electrodes for measuring the selected virtual biological signals. Examples of the display device 30 are a device for displaying locations on a screen or on paper. However, the invention is not limited thereto.

Hereinafter, the parameter determining device 20 will be described in greater detail. Referring to FIG. 1, the parameter determining device 20 includes an input unit 21, a processor 22, a database 23, and an output unit 24. However, the parameter determining device 20 shown in FIG. 1 is merely an embodiment of the invention, and it would be obvious to one of ordinary skill in the art that various modifications may be made therein using the components shown in FIG. 1.

The input unit 21 receives inputs of characteristics of biological signals of a real body from the input device 10. Examples of characteristics of biological signals of a real body are waveform characteristics. Generally, biological signals may be represented as waves having signal amplitudes that change according to time, and waveform characteristic may refer to shapes of waveforms of the biological signals. For example, if a particular biological signal has a waveform characteristic in which three peaks are present per period, another biological signal may have a waveform characteristic in which two peaks are present per period. As another example, if a particular biological signal has a waveform characteristic in which the first one of three peaks per period is the greatest, another biological signal may have a waveform characteristic in which the second one of three peaks per period is the greatest. However, the invention is not limited thereto.

The processor 22 generates virtual biological signals from a virtual body model. As described above, the virtual body model refers to a virtual model representing a real body. The virtual body model is modeled by the processor 22. However, the invention is not limited thereto. For example, a virtual body model may be externally input and stored in the database 23 in advance. Generally, such a virtual body model indicates electric characteristics at locations of a virtual body that are induced by virtual internal organs of the virtual body. For example, if the virtual internal organ is a virtual heart, the virtual body model may indicate electric characteristics on a surface of the virtual body that are induced by activities of the virtual heart, in correspondence to locations on the surface of the virtual body. The processor 22 generates virtual biological signals based on differences between electric characteristics at locations on the surface of the virtual body. Here, electric characteristic may refer to potential, and the difference between the electric characteristics may refer to a difference between potentials or voltages. However, the invention is not limited thereto.

Examples of the virtual biological signals are electrocardiogram (ECG) signals. However, according to embodiments of the invention, the virtual biological signals may not only be ECG signals, and may be various other virtual biological signals that may be electrically detected in a virtual body, such as brain waves, electromyogram (EMG) signals, etc.

The processor 22 generates a plurality of virtual biological signals from a virtual body model. In detail, the processor 22 may generate a plurality of virtual biological signals from a virtual body model by changing parameters that determine characteristics of biological signals of the virtual body model. Here, the parameters refer to information regarding locations on a surface of the virtual body. In other words, the processor 22 may generate a plurality of virtual biological signals from a virtual body model by changing at least one location on a surface of the virtual body.

A virtual body model indicates electric characteristics respectively correspond to locations on a surface of the virtual body that are induced by activities of internal organs in the virtual body. Therefore, electric characteristics of locations on a surface of the virtual body differ from each other. The processor 22 generates a plurality of virtual biological signals by using properties of a virtual body model. For example, after the processor 22 generates a virtual biological signal based on a difference between electric characteristics of two predetermined locations on the surface of the virtual body, the processor 22 may change at least one of the two locations and generate another virtual biological signal with respect to the changed locations.

The plurality of virtual biological signals generated by the processor 22 have characteristics that are different from one another. Here, the term characteristics may refer to waveform characteristics. However, the invention is not limited thereto. Generally, virtual biological signals may be represented as waves having signal amplitudes that change according to time. Furthermore, the virtual biological signals may be generally represented as waves having signal amplitudes that change periodically and repeatedly. Therefore, waveform characteristics of virtual biological signals may be represented by characteristics of periodical and repetitive changes of the signal amplitudes of the waves. For example, one of the biological signals may have a waveform characteristic that a size ratio between the former one and the latter one of two peaks within a single period of the biological signal is 2:1, whereas another one of biological signals may have a waveform characteristic that a size ratio between the former one and the latter one of two peaks within a single period of the biological signal is 1:1.

The processor 22 selects at least one virtual biological signal indicating characteristics of a biological signal of a real body by comparing the plurality of virtual biological signals. Here, the phrase characteristics of a biological signal of a real body refers to waveform characteristics. However, the invention is not limited thereto. Furthermore, the characteristics of a biological signal of a real body correspond to the waveform characteristics of the virtual biological signals, as described above. However, while the waveform characteristics of the virtual biological signals, as described above, are based on virtual signals, the characteristics of a biological signal of a real body are based on biological signals measured from the real body.

The processor 22 compares the waveform characteristics of the plurality of virtual biological signals to the waveform characteristics of the biological signals of the real body and selects at least one of the plurality of virtual biological signals based on a result of the comparison. For example, the processor 22 may select a virtual biological signal having a waveform characteristic that best matches the corresponding waveform characteristic of the biological signals of the real body from among the plurality of virtual biological signals.

The processor 22 outputs parameters used to generate the virtual biological signal selected from among the plurality of virtual biological signals. Here, as described above, the parameters may be information regarding locations of electrodes for measuring the selected virtual biological signals. Furthermore, the processor 22 may determine a plurality of parameters respectively in correspondence with characteristics of the biological signals of the real body and output the plurality of parameters.

In detail, the processor 22 may select any one of the plurality of virtual biological signals corresponding to any one of characteristics of the biological signals of the real body by comparing the plurality of virtual biological signals, output parameters corresponding to the selected virtual biological signal, select another one of the plurality of virtual biological signals corresponding to another one of characteristics of the biological signals of the real body by comparing the plurality of virtual biological signals, and output parameters corresponding to the selected virtual biological signal. Furthermore, the virtual biological signals and the parameters corresponding to the virtual biological signals may be mapped to each other and stored in the database 23. Examples of the database 23 may be a hard disk drive, a read only memory (ROM), a random access memory (RAM), a flash memory, and a memory card, but the database 23 is not limited to these examples.

The output unit 24 outputs parameters used to generate the selected virtual biological signal to the display device 30. As described above, the parameters may be information regarding locations of electrodes for measuring the selected virtual biological signal. The display device 30 displays the locations based on the information output by the output unit 24. Examples of the display device 30 are a device for displaying locations on a screen or on paper. However, the invention is not limited thereto.

Information regarding the locations displayed by display device 30 may be utilized by a user. For example, a user may utilize information of the locations displayed by the display device 30 as parameters for designing a biological signal measuring device. In this case, the user may arrange measuring electrodes on a side surface of the biological signal measuring device by using the information regarding the locations. However, the information regarding the locations may be used not only for designing a biological signal measuring device, but also for various other purposes. For example, a user may utilize the information regarding locations as information for arranging actual measuring electrodes used for measuring biological signals of the user or an examinee other than the user on the skin of the user or the examinee other than the user. Generally, the information regarding the locations may include at least one of a location of at least one of a plurality of virtual electrodes and a direction from at least one of the virtual electrodes to at least one other one of the virtual electrodes. Furthermore, the plurality of parameters may be displayed on the display device 30. Therefore, a user may be provided a plurality of parameters respectively matched to a plurality of characteristics of the biological signals of the real body.

As described above, a user may input characteristics of the biological signals of the real body by using an input device. In this case, the user may acquire information regarding locations corresponding to the input characteristics. Here, the processor 22 selects virtual biological signals having characteristics that best match the characteristics of the biological signals of the real body input via the input device 10, and the output unit 24 outputs locations of the selected virtual biological signals to the display device 30. As described above, a user may inquire locations of optimal measuring electrodes having desired waveform characteristics and receive information regarding locations in response thereto. Furthermore, a user may design a biological signal measuring device by using the information regarding the locations or may arrange actual measuring electrodes for measuring biological signals of the user or an examinee other than the user with reference to the information regarding the locations.

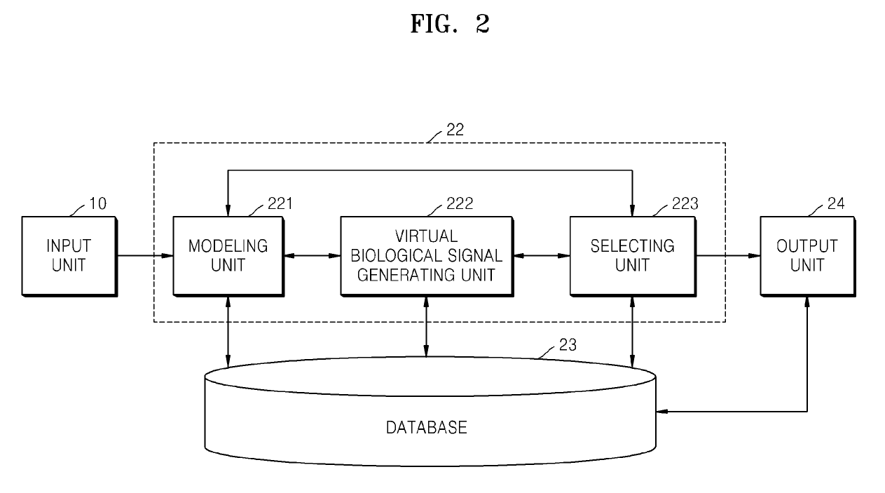

FIG. 2 is a diagram showing the configuration of the processor 22 according to an embodiment of the invention. Referring to FIG. 2, the processor 22 includes a modeling unit 221, a virtual biological signal generating unit 222, and a selecting unit 223. However, the processor 22 shown in FIG. 2 is merely an embodiment of the invention, and it would be obvious to one of ordinary skill in the art that the processor 22 may be modified. For example, the processor 22 may be manufactured with dedicated chips that perform functions of the above components or may be embodied as a dedicated computer program stored in a general purpose CPU and the database 23, or as a special purpose computer.

The modeling unit 221 configures a virtual body model. In detail, the modeling unit 221 may configure the virtual body model by activating the virtual body model stored in the database 23. Furthermore, the virtual body model is modeled by the modeling unit 221. However, configuration of the virtual body model is not limited to this embodiment. For example, the virtual body model may be externally input. Hereinafter, a case in which a virtual body model is modeled by the modeling unit 221 will be described for convenience of explanation. However, the invention is not limited thereto.

The modeling unit 221 models a virtual body model. Generally, the virtual body model includes internal organs of a virtual body and a surface of the virtual body. Here, examples of the virtual body model may be a virtual human body model, examples of the internal organs may be a virtual heart, and examples of the surface may be a virtual human skin. However, the invention is not limited thereto.

A virtual body model indicates electric characteristics at locations on a surface of a virtual body that are induced by activities of virtual internal organs of the virtual body. For example, if the virtual internal organ is a virtual heart and the surface is a virtual skin, the virtual body model may indicate electric characteristics at locations on the virtual skin of the virtual body that are induced by activities of the virtual heart, in correspondence to locations on the surface of the virtual body. The processor 22 generates virtual biological signals based on differences between electric characteristics at locations on the surface of the virtual body. Generally, a virtual body model reflects characteristics of a real body. Therefore, electric characteristics indicated by the virtual body model may correspond to electric characteristics at locations on a surface of the real body.

Generally, activities of internal organs in a real body induce electric characteristics on a surface of the real body. For example, activity current generated by the ventricles and muscular contraction of the heart of a real body may induce electric characteristics on a surface of the real body. However, the induction of electric characteristics by activities of the heart is merely an example, and it would be obvious to one of ordinary skill in the art to apply various other applications thereof.

The modeling unit 221 configures a virtual body model with reference to electric characteristics induced to the skin of a real body by the internal organs in the real body. Here, as described above, the most common examples of the internal organs in the real body are the heart, whereas the most common examples of the surface of the real body are the skin. In detail, the modeling unit 221 configures a virtual body model in consideration of electric characteristics induced to the skin of a real body by activities of the heart of the real body. Here, the virtual body model may be configured by configuring a model of activities of a virtual heart and a model of electric characteristics induced to the skin by the activities of the real heart, and integrating the two models. However, the embodiment is merely an example of virtual body model configurations, and it would be obvious to one of ordinary skill in the art to make various other embodiments. Hereinafter, for convenience of explanation, an example of configurations of a virtual body model in the case where the internal organ of a virtual body is the heart and the surface of the virtual body is the skin will be described. However, the invention is not limited thereto.

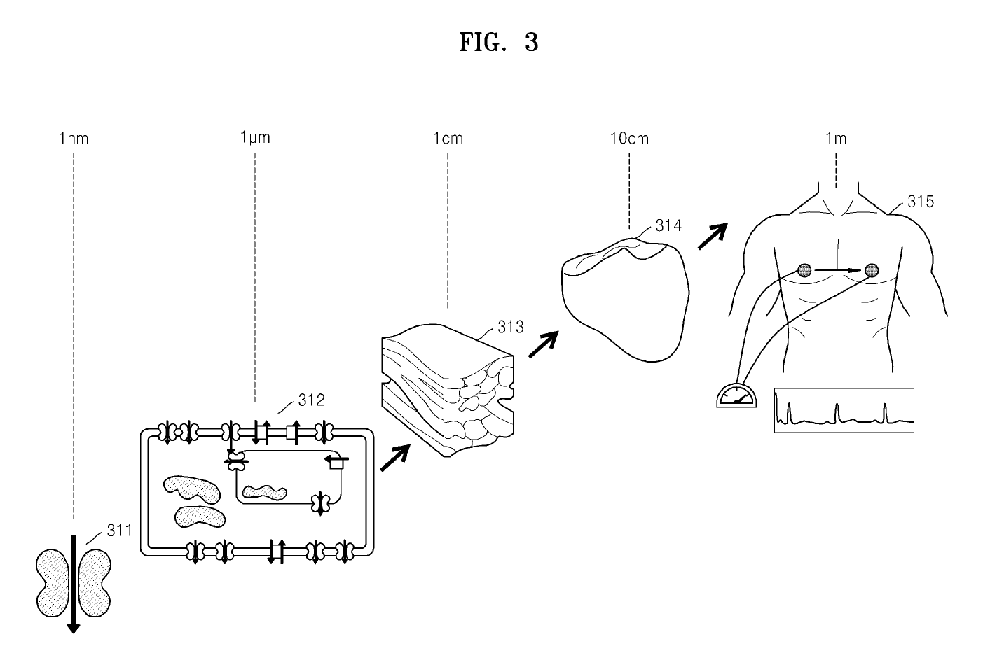

FIG. 3 is a diagram showing a process of configuring a virtual body model. As shown in FIG. 3, the modeling unit 221 configures a virtual body model in consideration of characteristics of a real body. For example, the modeling unit 221 may configure a virtual body model based on a numerical analysis of characteristics of a real body. Furthermore, as described above, the modeling unit 221 configures a virtual heart model first, and configures a model of electric characteristics induced to the virtual skin by the activities of the virtual heart by using the virtual heart. Therefore, a virtual body model may be configured.

First, a virtual heart model configured by the modeling unit 221 will be described. Generally, the virtual heart model may be configured by modeling characteristics of activities of myocardial cells constituting a virtual heart and modeling electric conduction characteristics of tissues of a heart formed of myocardial cells based on the model of the characteristics of activities of the myocardial cells. Here, the model of the characteristics of activities of virtual myocardial cells and the model of the electric conduction characteristics of the virtual tissues may be numerically analyzed. However, the invention is not limited thereto.

Referring to FIG. 3, the modeling unit 221 may embody virtual myocardial cells in consideration of characteristics of activities of actual myocardial cells 312. The real myocardial cell 312 of a real heart 314 generates electric characteristics of electric excitation with respect to the real myocardial cell 312 and mechanical contraction of the real myocardial cell 312 due to the excitation. In detail, the real myocardial cell 312 mechanically contracts due to electric excitation, electric currents flow in and out by biological ions via a portion 311 of a tissue of the real myocardial cell 312 due to the contraction, and the electric currents generate electric characteristics of the real myocardial cell 312. The modeling unit 221 embodies an electric current for inducing excitation of a virtual myocardial cell and electric currents that flow in and out of the virtual myocardial cell due to mechanical contraction of the virtual myocardial cell and numerically defines a relationship between the currents and changes of voltage characteristics of the virtual myocardial cell due to the currents, as defined by Equation 1 below. Therefore, the virtual myocardial cell may be embodied. Here, Cₘ denotes electric capacitance of the virtual myocardial cell, V denotes internal voltage of the virtual myocardial cell, Iᵢₒₙ denotes a total current that flows into the virtual myocardial cell via a portion of a tissue by biological ions, and Iₛₜᵢₘ denotes a perturbation current for inducing excitation of the virtual myocardial cell. Furthermore, examples of the biological ions may be sodium, potassium, calcium, and chlorine. However, the invention is not limited thereto.

$${C}_{m} \frac{d {V}_{m}}{d t} = - ( {I}_{ion} + {I}_{stim} ) \qquad [ Equation 1 ]$$

Furthermore, the total current that flows into the virtual myocardial cell via a portion of a tissue by biological ions may be represented as a sum of currents of biological ions that flow in and out of the real myocardial cell 312, as defined by Equation 2. Here, the magnitude of each of the currents of the biological ions may be indicated by I and the subscript of an element symbol representing the corresponding each of biological ions.

Iᵢₒₙ=I_{Na}+I_{K1}+Iₜₒ+I_{Kr}+I_{CaL}+I_{NaCa}+I_{NaK}+I_{pCa}+I_{pK}+I_{bCa}+I_{bNa} [Equation 2]

As described above, the modeling unit 221 may configure a cytophysiological model that simulates excitation and contraction of virtual myocardial cells and may configure virtual myocardial cells based on the cytophysiological model. However, the cytophysiological model is defined only for convenience of explanation, and the invention is not limited to such a model.

Referring to FIG. 3, the modeling unit 221 may embody a numerical analysis of electric conduction characteristics of the virtual tissues in consideration of electric conduction characteristics of tissues 313 of the heart 314 formed of the real myocardial cells 312. The real myocardial cells 312 constituting the real heart 314 are components of the tissues 313 of the real heart 314. Generally, the tissue 313 includes a region inside the real myocardial cell 312 and a region outside the real myocardial cells 312, which is filled with interstitial fluid. Furthermore, the tissue 313 is formed of a structure in which the region inside the real myocardial cells 312 and the region outside the real myocardial cells 312 are successively arranged. Therefore, a unit region including regions inside and outside the real myocardial cells 312 operates as a volume conductor having electric conduction characteristics. At this point, the amounts of the currents due to the biological ions, as described above, are maintained as the currents flow from the region inside the real myocardial cells 312 to the region outside the real myocardial cells 312 or vice versa. The modeling unit 221 may define a characteristic in which a sum of a current density per unit area inside the virtual myocardial cell and a sum of a current density per unit area outside the virtual myocardial cell are constantly maintained, as defined by Equation 3. Here, Jᵢ(x,t) denotes a current density per unit area inside a virtual myocardial cell, the Jₑ(x,t) denotes a current density per unit area outside a virtual myocardial cell, and x denotes a space coordinate vector.

∇·(Jᵢ(x,t)+Jₑ(x,t))=0 [Equation 3]

Furthermore, the modeling unit 221 may induce a reactive diffusion equation with respect to a membrane potential of a tissue, as defined by Equation 4, by embodying electric conduction characteristics of the tissue by using a mono-domain method based on Equations 1 and 3. Here, Vₘ denotes a membrane potential conducted to a virtual tissue membrane, Cₘ denotes capacitance per unit area of the virtual tissue membrane, Iₐₚₚ denotes a magnitude of a stimulating current per unit area of the virtual tissue membrane, Iᵢₒₙ denotes magnitudes of currents that flow in and out by biological ions per unit area of the virtual tissue membrane, β denotes a ratio between the surface area of the virtual heart with respect to the volume of the virtual heart, G denotes electric conductivity of the virtual tissue, σ_{mL} denotes electric conductivity of the virtual tissue in the grain-wise direction, and σ_{mT} denotes electric conductivity of the virtual tissue in a direction perpendicular to the grain of the virtual tissue.

$${C}_{m} \frac{\partial {V}_{m}}{\partial t} = \frac{1}{β} ∇ \cdot ( G ( {σ}_{mL} , {σ}_{mT} ) ∇ {V}_{m} ) - {I}_{ion} - {I}_{app} \qquad [ Equation 4 ]$$

Furthermore, the modeling unit 221 utilizes the finite elements method to interpret Equation 4. Therefore, the modeling unit 221 may use a spontaneous algebraic equation employing status values at mesh points as variables, as defined by Equation 5, by applying Galerkin's method and Euler's explicit method with respect to Equation 4. Here, K denotes a stiffness matrix, X denotes a variable vector at each lattice point, and R denotes an external force derivative. Furthermore, the modeling unit 221 may calculate values respectively corresponding to each of time points according to Equation 5. Here, the modeling unit 221 may calculate values respectively corresponding to each of time points by using the Newton-Raphson method. The values may represent electric characteristics appearing on the heart. For example, the values may indicate potentials formed on the heart due to activities of the virtual heart.

KX=R [Equation 5]

As described above, the modeling unit 221 may embody a virtual heart model in a numerical analysis fashion through modeling for expanding electric conduction characteristics of tissues of a virtual heart to the entire virtual heart based on a cytophysiological model of virtual myocardial cells. However, the invention is not limited thereto.

Referring to FIG. 3, the modeling unit 221 configures a model of electric characteristics that are induced on the virtual skin by activities of the virtual heart. As described above, electric characteristics of a real heart, which are generated by activities of the real heart, induce electric characteristics on the skin. The modeling unit 221 may configure a model of electric characteristics that are induced on the virtual skin by activities of the virtual heart by using a virtual heart model in consideration of activities of the real heart and electric characteristics induced on the real skin due to the activities of the real heart. Here, the electric characteristics induced to the virtual skin may be mapped to values corresponding to time points as calculated in Equation 5 by using the boundary elements method, as defined by Equation 6. Here, Φₑₖ(r) denotes potential at a location r on a curved surface k, σₖ⁻ denotes electric conductivity inside the curved surface k, σₖ⁺ denotes electric conductivity outside the curved surface k, J_{c} denotes a current density field, and Φₑ(r) denotes values corresponding to time points as calculated in Equation 5. Furthermore, Equation 6 is a function disclosed in M. Potse et al., 2009, “Cardiac anisotropy in boundary-element models for the electrocardiogram,” Medical & Biological Engineering & Computing, Volume 47, No. 7, pp. 719-729, as an example of boundary elements methods. Therefore, a detailed description of Equation 6 will not be provided herein.

$${Φ}_{ek} ( r ) = \frac{1}{2 π ( {σ}_{k}^{-} + {σ}_{k}^{+} )} \cdot [ \int {J}_{c} ( {r}^{′} ) \cdot \frac{r - {r}^{′3}}{{\vert r - {r}^{′} \vert}^{3}} d V + {\sum }_{I} {\int }_{SI} ( {σ}_{l}^{-} - {σ}_{l}^{+} ) {Φ}_{e} ( {r}^{″} ) d {Ω}_{{rr}^{″}} ] \qquad [ Equation 6 ]$$

As described above, the modeling unit 221 may configure a virtual body model which indicates electric characteristics on a surface of a virtual body that are induced by activities of a virtual heart of the virtual body. Here, electric characteristic at a particular location on a surface of a virtual body may be represented with Φₑₖ(r) of Equation 6.

The virtual biological signal generating unit 222 generates a plurality of virtual biological signals from a virtual body model by changing parameters of the virtual body model. As described above, electric characteristics appear at locations on a surface of the virtual body due to activities of a virtual heart. The virtual biological signal generating unit 222 generates virtual biological signals based on a difference between electric characteristics of at least two points on the surface of the real body. Here, the terms electric characteristic may refer to potential, and, as described above, may refer to Φₑₖ(r) of Equation 6. Furthermore, a difference between electric characteristics of at least two locations on a surface of a real body may refer to a potential difference or a voltage difference, and the difference between electric characteristics of at least two locations on a surface of a real body may refer to a difference between electric characteristic of one of the at least two points on the surface of the real body and electric characteristic of the other one of the at least two points on the surface of the real body. Furthermore, the virtual biological signals may be represented as graphs in which a difference between electric characteristics changes according to time. Furthermore, the virtual biological signals generated by the virtual biological signal generating unit 222 may correspond to actual biological signals that are acquired from differences of electric characteristics induced on the real skin by activities of the real heart in the real body.

The virtual biological signal generating unit 222 generates virtual biological signals from differences between electric characteristics at particular locations on a surface of a virtual body. Generally, actual electrodes are attached to the skin of an examinee and are used to detect differences between electric characteristics at locations on the skin of the examinee. On the contrary, the virtual electrodes are used to identify locations on the virtual body. For example, two virtual electrodes are arranged at two locations on a surface of the virtual body by the virtual biological signal generating unit 222, and the virtual biological signal generating unit 222 may detect a difference between electric characteristics of the locations at which the virtual electrodes are located. If a number of locations of a virtual examinee is limited to 9000 nodes, each of the virtual electrodes may move to any one of the 9000 nodes, and differences between electric characteristics of the nodes to which the virtual electrodes are moved are detected by the virtual biological signal generating unit 222. Generally, a difference between electric characteristics is generated from a difference between electric characteristics of two locations on the virtual skin. However, the invention is not limited thereto. For example, according to various embodiments of the invention, a difference between electric characteristics may be generated based on a difference between electric characteristics of any one of the locations on the virtual skin and a virtual ground or differences between electric characteristics of three of locations on the virtual skin.

The virtual biological signal generating unit 222 may generate a virtual biological signal having a different waveform characteristic based on at least one changed locations. In detail, the virtual biological signal generating unit 222 may generate a first virtual biological signal based on a difference between electric characteristics of predetermined locations from among the locations on the virtual skin, e.g., two locations from among the locations on the virtual skin, may change at least one of the two locations, and may generate a second virtual biological signal different from the first virtual biological signal based on a difference between electric characteristics of the changed locations.

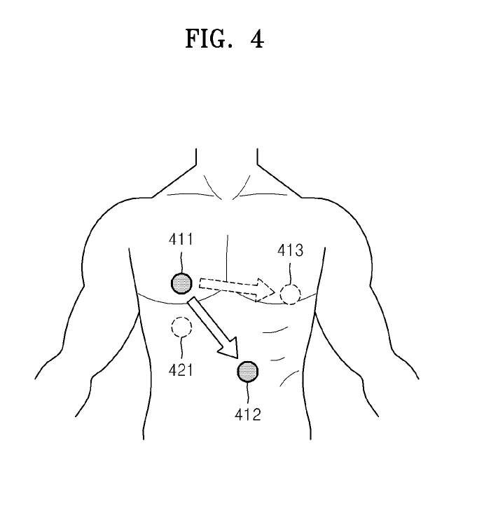

Here, the first virtual biological signal and the second virtual biological signal have different waveform characteristics. As described above, the waveform characteristic may represent characteristic of periodical and repetitive change of sizes. In other words, the waveform characteristic is determined based on sizes of peaks of virtual biological signals, and a characteristic of periodical and repetitive change of size within a virtual biological signal may differ from a characteristic of periodical and repetitive change of size within another virtual biological signal. For example, if a first virtual biological signal has a waveform characteristic where a size ratio between the former one and the latter one of two peaks within a single period of the biological signal is 2:1, a second virtual biological signal may have a waveform characteristic where a size ratio between the former one and the latter one of two peaks within a single period of the biological signal is 1:1. In this case, the first virtual biological signal has a waveform characteristic that is advantageous for identifying the former one of the two peaks, whereas the second virtual biological signal has a waveform characteristic that is advantageous for identifying the latter one of the two peaks. Detailed descriptions thereof will be given as follows with reference to FIG. 4.

FIG. 4 shows locations of virtual electrodes and an example in which at least one of the locations is changed. Hereinafter, an example of generating virtual biological signals based on changed locations will be described. For convenience of explanation, it is assumed that the internal organ of a virtual body is a virtual heart, the surface of the virtual body is the skin, virtual biological signals are virtual ECG signals detected on the virtual skin due to activities of the virtual heart, a pair of virtual electrodes are provided, and the virtual ECG signals are detected based on a difference between electric characteristics of two locations on the virtual skin. However, the invention is not limited thereto.

Referring to FIG. 4, the virtual biological signal generating unit 222 locates one of the virtual electrodes (first virtual electrode) at a first location 411 from among all of the locations on the virtual skin, locates the other one of the virtual electrodes (second virtual electrode) at a second location 412 from among all of the locations on the virtual skin, and generates a virtual biological signal based on a difference between electric characteristics of the first and second locations 411 and 412. Here, a total number of locations on the virtual skin may be limited to a finite number. However, the invention is not limited thereto. For example, a total number of locations on the virtual skin may be limited to 9,000 locations. The virtual biological signal generating unit 222 may change a location of the second virtual electrode from the second location 412 to a third location 413 and may generate a virtual biological signal different from the previously generated virtual biological signal based on a difference between electric characteristics of the first and third locations 411 and 413. Then, the virtual biological signal generating unit 222 may generate a plurality of virtual biological signals by changing the location of at least one of the second virtual electrodes to any one of all of the locations. For example, if a total number of locations is determined to be 9,000, the virtual biological signal generating unit 222 may acquire 8,999 virtual biological signals by fixing the location of the first virtual electrode to the first location 411 and changing the location of the second virtual electrode to other locations. Here, the plurality of virtual biological signals have different waveform characteristics as described above. Furthermore, the virtual biological signal generating unit 222 may acquire more virtual biological signals by changing the location of the first electrode from the first location 411 to a fourth location 421 and changing the location of the second electrode to other locations.

According to another embodiment of the invention, the virtual biological signal generating unit 222 may determine a distance between the virtual electrodes and may detect a plurality of virtual biological signals based on the determined distance. For example, if a distance between the plurality of virtual electrodes is determined to be 3 cm, the virtual biological signal generating unit 222 may detect a plurality of virtual biological signals while a distance between a first virtual electrode and a second virtual electrode is maintained as 3 cm. Therefore, the virtual biological signal generating unit 222 may effectively utilize time and resources for detecting a plurality of virtual biological signals. Furthermore, a distance between virtual electrodes may be determined as one of all values in a range including the maximum and the minimum values. For example, a distance between a first virtual electrode and a second virtual electrode is determined to be 3 cm, the virtual biological signal generating unit 222 may detect a plurality of virtual biological signals based on differences between electric characteristics of locations that are distances from 2.5 cm to 3.5 cm apart from each other. The distance between the virtual electrodes may be input by a user. Here, the input unit 21 forwards information regarding a distance between virtual electrodes input by the input device 10 to the virtual biological signal generating unit 222. However, embodiments of the invention are not limited thereto. For example, the distance between the virtual electrodes may be preset as a default value.

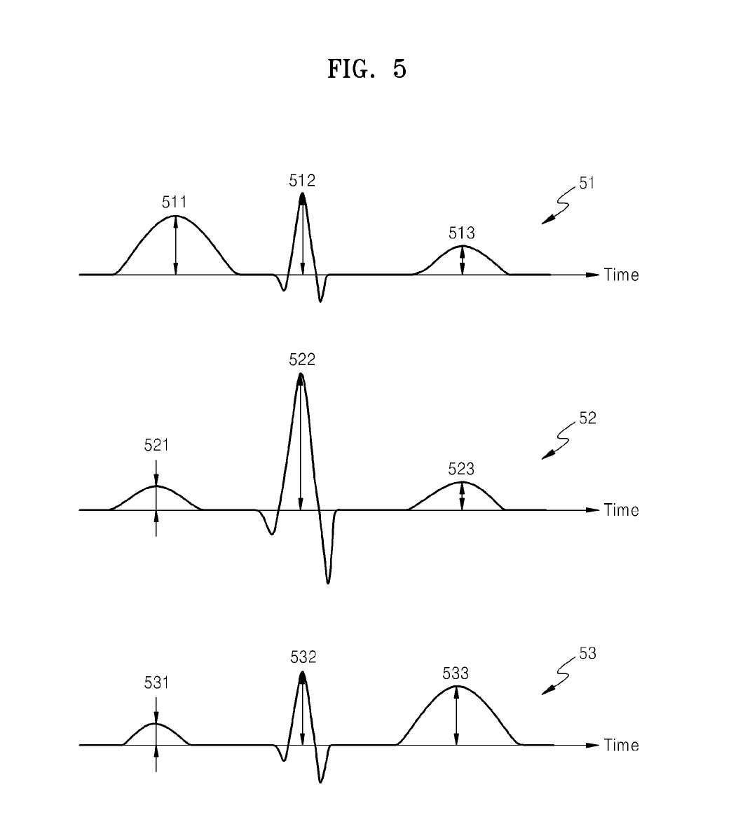

FIG. 5 shows a plurality of virtual biological signals. Hereinafter, differences between waveform characteristics of a plurality of virtual biological signals generated based on different locations will be described with reference to FIG. 5. For convenience of explanation, it is assumed that the internal organ of a virtual body is a virtual heart, the surface of the virtual body is the skin, virtual biological signals are virtual ECG signals detected on the virtual skin due to activities of the virtual heart, a pair of virtual electrodes are provided, and the virtual ECG signals are detected based on a difference between electric characteristics of two locations on the virtual skin. However, the invention is not limited thereto.

Referring to FIG. 5, a plurality of ECG signals indicate different waveform characteristics, respectively. Generally, in an ECG signal, a P waveform, an R waveform, and a T waveform are periodically formed. Here, the P waveform, the R waveform, and the T waveform may indicate a P peak, an R peak, and a T peak, respectively. Each of the peaks has a different role for analysis of an ECG signal. For example, the R waveform is used for analysis of a heart rate.

As described above, a plurality of virtual ECG signals 51, 52, and 53 shown in FIG. 5 are detected from different locations, respectively. Therefore, the plurality of virtual ECG signals 51, 52, and 53 have different waveform characteristics, respectively. For example, the size of a P peak 511 of the virtual ECG signal 51 may be relatively larger than P peaks 521 and 531 of the other virtual ECG signals 52 and 53. In the same regard, the size of an R peak 522 of the virtual ECG signal 52 may be relatively larger than R peaks 512 and 532 of the other virtual ECG signals 51 and 53. In the same regard, the size of a T peak 533 of the virtual ECG signal 53 may be relatively larger than T peaks 513 and 523 of the other virtual ECG signals 51 and 52.

A waveform characteristic may be indicated by a description of the waveform characteristic. Referring to FIG. 5, information regarding the waveform characteristic of the ECG signal 51 may be indicated by “P waveform” since the ECG signal 51 has the largest P peak, information regarding the waveform characteristic ECG signal 52 may be indicated by “R waveform” since the ECG signal 52 has the largest R peak, and information regarding the waveform characteristic of the ECG signal 53 may be indicated by “T waveform” since the ECG signal 53 has the largest T peak.

The selecting unit 223 compares a plurality of virtual biological signals and selects at least one virtual biological signal exhibiting a characteristic of a biological signal of a real body. Here, a characteristic of a biological signal of a real body may refer to a waveform characteristic. Furthermore, a waveform characteristic of a biological signal of a real body corresponds to a waveform characteristic of a virtual biological signal, as described above. However, as described above, unlike a virtual biological signal, the characteristic of a biological signal of a real body is detected from the real body.

The selecting unit 223 compares waveform characteristics of a plurality of virtual biological signals and selects a virtual biological signal exhibiting a waveform characteristic of a biological signal of a real body from among the plurality of virtual biological signals. Generally, a selected virtual biological signal may be a virtual biological signal exhibiting a waveform characteristic of a biological signal of a real body most closely from among the plurality of virtual biological signals.

As shown in FIG. 5, if a waveform characteristic of an ECG signal of a real body is “R waveform”, the selecting unit 223 may select the ECG signal 52 having the largest R peak from among the plurality of virtual ECG signals. However, embodiments of the invention are not limited thereto. For example, if a waveform characteristic of an ECG signal of a real body is “R waveform”, the selecting unit 223 may select an ECG signal having “R waveform” and “P waveform” in a 1:1 ratio from among the plurality of ECG signals.

The selecting unit 223 maps waveform characteristics of the plurality of virtual biological signals to parameters used for generating the plurality of virtual biological signals. Here, the waveform characteristic may be indicated by descriptions of the waveform characteristics.

Referring to FIG. 5, information regarding the waveform characteristic of the ECG signal 51 may be indicated by “P waveform” since the ECG signal 51 has the largest P peak, information regarding the waveform characteristic of the ECG signal 52 may be indicated by “R waveform” since the ECG signal 52 has the largest R peak, and information regarding the waveform characteristic of the ECG signal 53 may be indicated by since the ECG signal 53 has the largest T peak. As described above, the parameters may refer to information regarding locations at which the plurality of virtual biological signals are detected. Furthermore, the information regarding the locations may include at least one of a location of at least one of a plurality of virtual electrodes and a direction from at least one of the virtual electrodes to at least one other one of the virtual electrodes.

Referring to FIGS. 4 and 5, information regarding the location of the ECG signal 52 that is detected based on a difference between electric characteristics of the first location 411 and the second location 412 may include information regarding the first location 411 and the second location 412 or information regarding the first location 411 and information regarding a direction from the first location 411 toward the second location 412. However, information regarding locations including the information regarding the first location 411 and the information regarding a direction from the first location 411 toward the second location 412 may further include information regarding a distance between the first location 411 and the second location 412. However, if information regarding a distance between virtual electrodes is input by a user, as described above, information regarding a distance between the first location 411 and the second location 412 may be omitted. Furthermore, the selecting unit 223 stores waveform characteristics of the mapped plurality of virtual biological signals and parameters used for measuring the plurality of virtual biological signals in the database 23.

The selecting unit 223 according to another embodiment of the invention may compare a plurality of virtual biological signals, select at least one waveform characteristic from among waveform characteristics of the plurality of virtual biological signals, and map the virtual biological signals having the selected at least one waveform characteristic and locations at which the virtual biological signals having the selected at least one waveform characteristic are detected. In other words, the selecting unit 223 may map only some of the waveform characteristics instead of mapping all waveform characteristics of a plurality of virtual biological signals detected from combinations of all locations on the virtual skin.

As shown in FIG. 5, the mapping unit 23 may compare a plurality of ECG signals detected from combinations of all locations on the virtual skin, select the ECG signal 51 having a characteristic with the largest P peak from among the plurality of ECG signals, and map the waveform characteristic of the selected ECG signal 51 to the location at which the ECG signal 51 is detected. Also, the mapping unit 23 may compare a plurality of ECG signals detected from combinations of all locations on the virtual skin, select the ECG signal 52 having a characteristic with the largest R peak from among the plurality of ECG signals, and map the waveform characteristic of the selected ECG signal 52 to the location at which the ECG signal 52 is detected. Also, the mapping unit 23 may compare a plurality of ECG signals detected from combinations of all locations on the virtual skin, select the ECG signal 53 having a characteristic with the largest T peak from among the plurality of ECG signals, and map the waveform characteristic of the selected ECG signal 53 to the location at which the ECG signal 53 is detected.

According to another embodiment of the invention, a virtual biological signal may also be selected based on a similarity with a biological signal that is measured using at least one ECG standard lead. Generally, ECG standard leads include 12 standard leads that are used for ECG measurement. The ECG standard leads include 3 bipolar limb leads named leads I, II, and III that are obtained from 3 electrodes attached to the right arm, the left arm, and the left leg, 3 unipolar augmented limb leads named aVR, aVL, and aVF that are also obtained from the 3 electrodes attached to the right arm, the left arm, and the left leg, and 6 unipolar chest or precordial leads named leads V1, V2, V3, V4, V5, and V6 that are obtained from 6 electrodes attached to the chest to measure the heart's electrical activity in a slightly off-horizontal plane.

The ECG standard leads output ECG signals with different waveform characteristics. Therefore, the selecting unit 223 may select a virtual biological signal based on similarities between waveform characteristics of ECG signals measured using the ECG standard leads and waveform characteristics of ECG signals measured using a virtual body model. For example, the selecting unit 223 may select a waveform characteristic of a biological signal of a real body measured using the ECG standard lead II, compare waveform characteristics of a plurality of virtual biological with the waveform characteristic of the biological signal of the real body measured using the ECG standard lead II, and select one of the virtual biological signals having a waveform characteristic that most closely corresponds to the waveform characteristic of the biological signal of the real body measured using the ECG standard lead II.

The output unit 24 outputs parameters used for generating the selected virtual biological signal. Here, the parameters may be optimal parameters used for measuring biological signals of a real body. Furthermore, the parameters may be information regarding locations of virtual electrodes, as described above.

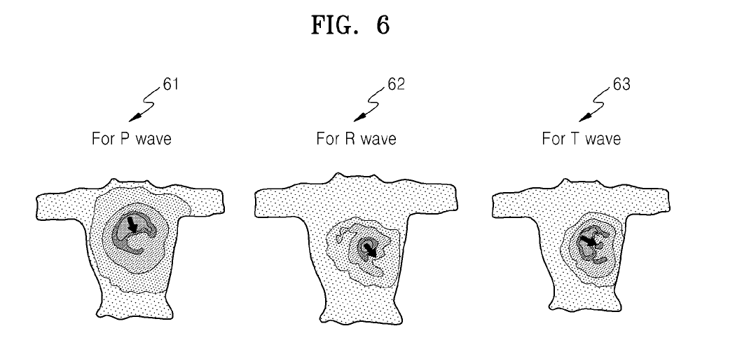

As shown in FIG. 5, the output unit 24 may output information regarding a location mapped to “R waveform”, which is any one of the waveform characteristics of the ECG signals 51, 52, and 53. Here, the information regarding the mapped location is information regarding a predetermined location on the virtual skin on which virtual electrodes are located to detect the ECG signal 52. A detailed description thereof will be given as follows with reference to FIG. 6.

FIG. 6 is a diagram showing waveform characteristics of a plurality of virtual biological signals and information regarding locations mapped to the waveform characteristics. Referring to FIG. 6, the output unit 24 outputs “P waveform” from among waveform characteristics of the plurality of virtual biological signals and information regarding locations of virtual electrodes for detecting the ECG signal 51 having the waveform characteristic corresponding to “P waveform” to the display device 30.

Referring to FIG. 6, the display device 30 may provide a display as indicated by the reference numeral 61 by using information regarding a waveform characteristic, which is “P waveform”, and information regarding locations related to “P waveform” that are forwarded from the output unit 24. Also, the display device 30 may provide a display as indicated by the reference numeral 62 by using information regarding a waveform characteristic, which is “R waveform”, and information regarding locations related to “R waveform” that are forwarded from the output unit 24. Also, the display device 30 may provide a display as indicated by the reference numeral 63 by using information regarding a waveform characteristic, which is “T waveform”, and information regarding locations related to “T waveform” that are forwarded from the output unit 24.

The output unit 24 may output information regarding locations mapped to waveform characteristics that are input by a user and are used for measuring biological signals of a real body from among a plurality of waveform characteristics by using the waveform characteristics input by the user. Here, the input unit 21 may forward information regarding waveform characteristics input via the input device 10 to the selecting unit 223, and the selecting unit 223 may forward the information regarding locations mapped to the waveform characteristics input by the user from among waveform characteristics of a plurality of virtual biological signals and the waveform characteristics input by the user to the output unit 24. However, embodiments of the invention are not limited thereto. For example, the output unit 24 may receive waveform characteristics input via the input unit 21 and extract information regarding locations mapped to the input waveform characteristics from the database 23.

Examples of the waveform characteristics input by a user are “P waveform”, “R waveform”, and “T waveform”, as described above. In this case, the user may select any one of a plurality of waveform characteristics, such as “P waveform”, “R waveform”, and “T waveform” by using the input device 10 and may be provided information regarding locations corresponding to the selected waveform characteristics via the display device 30. Therefore, the user may utilize the information regarding the locations as important information for designing a biological signals detecting device or for acquisition of biological signals of an examinee other than the user.

According to another embodiment of the invention, the input unit 21 receives biological information from the input device 10. The biological information may refer to biological information of a user or an examinee other than the user. Examples of the biological information may be height, body weight, body fat percentage, etc., of a user or an examinee other than the user. Other examples of the biological information may be structural information regarding biological organs of a user or an examinee other than the user. For example, if it is assumed that the biological organ is the heart, the structural information may include the location of the heart, the size of the heart, the angle of the heart, the thicknesses of the heart walls, etc.

According to the embodiment described above, the modeling unit 221 configures a virtual body model based on a virtual examinee or statistical data. On the contrary, in a case where a user inputs biological information, the modeling unit 221 configures a virtual body model based on the biological information. In detail, the modeling unit 221 utilizes such biological information as structural information regarding the internal organ of a virtual body, and thus, the modeling unit 211 may configure a virtual body model reflecting the biological information. Therefore, the parameter determining device 20 may output information regarding locations reflecting biological characteristics of a user or an examinee other than the user.

According to another embodiment of the invention, the input unit 21 receives lesion information from the input device 10. The lesion information may refer to variables inducing abnormal activities of the internal organs of a user or an examinee other than the user. For example, if the internal organ is the heart, the lesion information may be information regarding arrhythmia, premature ventricular contraction (PVC), right bundle branch block (RBBB), left bundle branch block (LBBB), ventricular hypertrophy, myocardial infarction, ventricular flutter, atrial flutter, atrial fibrillation, ventricular fibrillation, ventricular tachycardia, Brugada syndrome, etc., which induce abnormal activities of the heart. The modeling unit 21 configures a virtual body model based on the lesion information.

Generally, if there is an abnormality in the heart, an abnormality is found also in ECG signals due to activities of the heart. To reflect the abnormality, a modeling unit may configure a virtual body model that differs from a virtual body model of a normal person based on the lesion information. In detail, the modeling unit may configure a virtual body model reflecting input lesion information by utilizing the input lesion information as variables inducting abnormalities of the internal organs of the virtual body. Therefore, the parameter determining device 20 may not only output information regarding locations of measuring electrodes for measuring biological signals of a normal person, but also output information regarding locations of measuring electrodes for measuring biological signals of a person with a lesion.

According to another embodiment of the invention, the parameter determining device 20 may consider input lesion information as waveform characteristics and output information regarding locations mapped to the waveform characteristics. For example, if a biological signal is an ECG signal and lesion information is information regarding arrhythmia, the parameter determining device 20 may output information regarding locations mapped to a waveform characteristic that is indicated by “arrhythmia.” Here, the selecting unit 223 may select a virtual biological signal having a waveform characteristics effective for observing arrhythmia by comparing a plurality of virtual biological signals and may map the waveform characteristic of the selected virtual biological signal and locations at which the selected biological signal is measured. Here, the waveform characteristic indicated by “arrhythmia” may refer to a waveform characteristic with significant irregularity of amplitudes of peaks in several periods. However, it would be obvious to one of ordinary skill in the art that the selection may be made in various fashions based on statistical data or opinions of medical experts. The output unit 24 outputs the information regarding the locations mapped to the waveform characteristic indicated by “arrhythmia.” Therefore, a user may be provided with information regarding optimal locations of measuring electrodes for detecting a lesion including arrhythmia.

The parameter determining device 20 may be implemented by a single processor or a plurality of processors for determining optimal parameters used for measuring actual biological signals. The processor may be embodied as an array of a plurality of logic gates or a combination of a general purpose microprocessor and a non-transitory computer-readable medium having stored therein program instructions to be executed by the general purpose microprocessor. However, it would be obvious to one of ordinary skill in the art that the processor may be embodied as any of various other types of hardware.

The non-transitory computer-readable medium may also include, alone or in combination with the program instructions, data files, data structures, and the like. The non-transitory computer-readable medium and the program instructions stored therein may be specially designed and constructed, or may be of the kind well-known and available to those having skill in the computer software art. Examples of a non-transitory computer-readable medium include magnetic media such as hard disks, floppy disks, and magnetic tape; optical media such as CD-ROMs and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. In addition, the non-transitory computer-readable medium may be distributed among computer systems connected through a network so that the program instructions stored therein may be stored and executed in a decentralized manner.

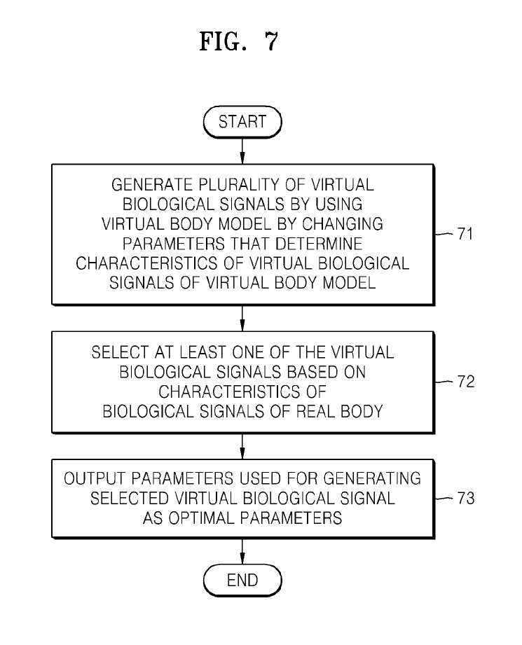

FIG. 7 is a flowchart of a method of determining parameters according to an embodiment of the invention. The method described with reference to FIG. 7 includes operations that are chronologically performed by the parameter determining device 20 shown in FIG. 1. Therefore, the descriptions provided above with respect to the parameter determining device 20 of FIG. 1 also apply to the method described with reference to FIG. 7.

In operation 71, the virtual biological signal generating unit 222 generates a plurality of virtual biological signals by using a virtual body model by changing parameters that determine characteristics of biological signals of a virtual body model. In operation 72, the selecting unit 223 selects at least one of the virtual biological signals based on characteristics of biological signals of a real body. In operation 73, the output unit 24 outputs the parameters used for generating the selected virtual biological signal as optimal parameters.

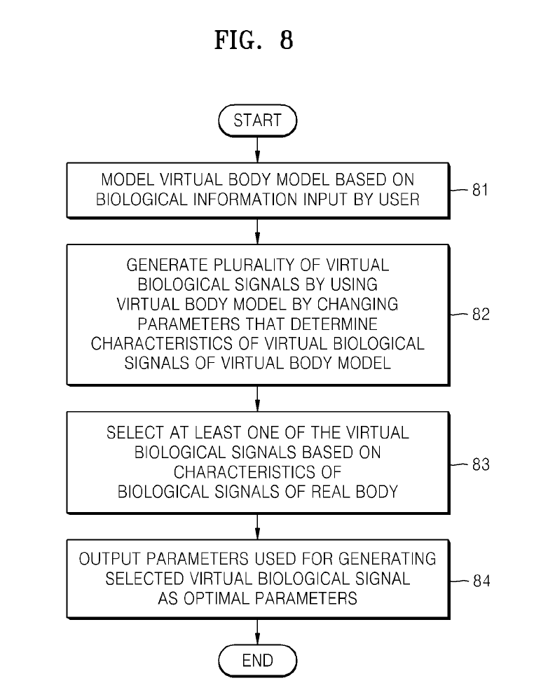

FIG. 8 is a flowchart of a method of determining parameters according to an embodiment of the invention. The method described with reference to FIG. 8 includes operations that are chronologically performed by the parameter determining device 20 shown in FIG. 1. Therefore, the descriptions provided above with respect to the parameter determining device 20 of FIG. 1 also apply to the method described with reference to FIG. 8.

In operation 81, the modeling unit 221 models a virtual body model based on biological information input by a user. In operation 82, the virtual biological signal generating unit 222 generates a plurality of virtual biological signals by using a virtual body model by changing parameters that determine characteristics of biological signals of a virtual body model. In operation 83, the selecting unit 223 selects at least one of the virtual biological signals based on characteristics of biological signals of a real body. In operation 84, the output unit 24 outputs the parameters used for generating the selected virtual biological signal as optimal parameters.

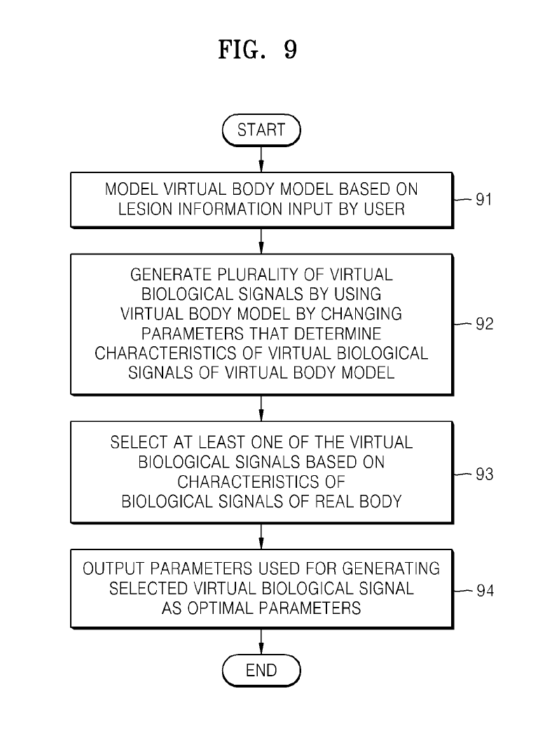

FIG. 9 is a flowchart of a method of determining parameters according to an embodiment of the invention. The method described with reference to FIG. 9 includes operations that are chronologically performed by the parameter determining device 20 shown in FIG. 1. Therefore, the descriptions provided above with respect to the parameter determining device 20 of FIG. 1 also apply to the method described with reference to FIG. 9.

In operation 91, the modeling unit 221 models a virtual body model based on lesion information input by a user. In operation 92, the virtual biological signal generating unit 222 generates a plurality of virtual biological signals by using a virtual body model by changing parameters that determine characteristics of biological signals of a virtual body model. In operation 93, the selecting unit 223 selects at least one of the virtual biological signals based on characteristics of biological signals of a real body. In operation 94, the output unit 24 outputs the parameters used for generating the selected virtual biological signal as optimal parameters.

Although several embodiments of the invention have been shown and described, it would be appreciated by those skilled in the art that changes may be made in these embodiments without departing from the principles and spirit of the invention, the scope of which is defined in the claims and their equivalents.

What is claimed is:

1. A method of determining optimal parameters for measuring biological signals of a real body by using a virtual body model modeling a virtual body simulating the real body, the method comprising:
generating a plurality of virtual biological signals of the virtual body using the virtual body model by changing parameters that determine characteristics of the virtual biological signals;
selecting at least one of the virtual biological signals based on a characteristic of one of the biological signals of the real body; and
outputting at least one parameter used to generate the selected at least one virtual biological signal as at least one optimal parameter for measuring the one biological signal of the real body.

2. The method of claim 1, wherein the selecting of at least one of the virtual biological signals comprises:
comparing one of the characteristics of the virtual biological signals with the characteristic of the one biological signal of the real body; and
selecting at least one of the virtual biological signals having a characteristic closest to the characteristic of the one biological signal of the real body.

3. The method of claim 1, further comprising modeling the virtual body model based on biological information input by a user.

4. The method of claim 3, wherein the biological information comprises structural information regarding internal organs of the virtual body.

5. The method of claim 1, further comprising modeling the virtual body model based on lesion information input by a user.

6. The method of claim 5, wherein the lesion information comprises information regarding variables that induce abnormalities of internal organs of the virtual body.

7. The method of claim 1, wherein the characteristic is a waveform characteristic of a waveform in a biological signal.

8. The method of claim 7, wherein the biological signal is an electrocardiogram (ECG) signal.

9. The method of claim 8, wherein the waveform comprises a P waveform of the ECG signal, or an R waveform of the ECG signal, or a T waveform of the ECG signal, or any combination thereof.

10. The method of claim 8, wherein the one biological signal of the real body is an ECG signal of the real body measured using an ECG standard lead; and
the selecting comprises:
comparing a waveform characteristic of the virtual ECG signals with a waveform characteristic of the ECG signal of the real body; and
selecting one of the virtual ECG signals having a waveform characteristic that is most similar to the waveform characteristic of the ECG signal of the real body.

11. The method of claim 1, wherein the parameters comprise information regarding locations of a plurality of electrodes for measuring the virtual biological signals.

12. The method of claim 11, wherein the information regarding locations comprises:
a location of at least one of the plurality of electrodes for measuring the virtual biological signals; and
a direction from the at least one of the plurality of electrodes to at least one other one of the plurality of electrodes.

13. The method of claim 1, wherein the virtual body model indicates electric characteristics at locations on a surface of the virtual body induced by activities of internal organs of the virtual body.

14. The method of claim 13, wherein the plurality of virtual biological signals are generated based on a difference between the electric characteristics at the locations on the surface of the virtual body.

15. The method of claim 14, wherein the generating of the plurality of virtual biological signals comprises:
generating at least one virtual biological signal at least one of the locations on the surface of the virtual body;
changing at least one of the locations on the surface of the virtual body; and
generating at least one virtual biological signal at the at least one location that has been changed.

16. The method of claim 15, wherein the changing of at least one of the locations comprises changing the at least one location based on information input by a user regarding a distance between the at least one location and at least one other one of the locations.

17. The method of claim 1, wherein the characteristic of the one biological signal of the real body is input by a user.

18. The method of claim 1, further comprising mapping the characteristics of the virtual biological signals to the parameters used for generating the virtual biological signals.

19. A non-transitory computer-readable medium having stored therein a computer program comprising program instructions for controlling a computer to perform the method of claim 1.

20. A parameter determining apparatus for determining optimal parameters for measuring biological signals of a real body by using a virtual body model modeling a virtual body simulating the real body, the apparatus comprising:
a database configured to store the virtual body model;
a processor configured to:
generate a plurality of virtual biological signals of the virtual body using the virtual body model by changing parameters that determine characteristics of the virtual biological signals;
select at least one of the virtual biological signals based on a characteristic of one of the biological signals of the real body; and
store the selected at least one virtual biological signal and at least one parameter used to generate at least one selected virtual biological signal in the database; and
an output unit configured to output the at least one parameter used to generate the selected at least one virtual biological signal as at least one optimal parameter for measuring the one biological signal of the real body.

21. The parameter determining apparatus of claim 20, further comprising an input unit via which the characteristics of the biological signals of the real body are input by a user.

22. The parameter determining apparatus of claim 20, wherein the processor models the virtual body model based on biological information and/or lesion information input by a user.
